(19) United States
(12) Patent Application Publication
(10) Pub. No.: US 2009/0114749 A1
(43) Pub. Date: May 7, 2009

(54) Methods and apparatus to make rubber crumb particles

(76) Inventor: David M. Futa, South Bend, IN (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/981,896

(22) Filed: Nov. 1, 2007

(51) Int. Cl. B02C 4/02

(52) U.S. Cl. 241/30; 241/206

(57) ABSTRACT

Methods and apparatus to make rubber crumb particles, are disclosed. An example method comprises rotating a pair of rigid rolls disposed closely adjacent one another via self-aligning bearings that support the rigid rolls with a preset gap therebetween, feeding material between the rigid rolls, and maintaining the preset gap to exceed the elastic limit of the material.

### FIELD OF THE DISCLOSURE

This disclosure relates generally to methods and apparatus to make fine particles, and, more particularly, to methods and apparatus to make rubber crumb particles.

### BACKGROUND

Worn materials, for example, rubber tires, have been recycled for resale as a constituent for manufacturing processes. Initially, recycling processes were used to make materials for planters, door mats, and loading dock bumpers. In recent years, tire recycling processes have progressed beyond the initial stages of producing relatively large portions of shredded tire material referred to as “chips”, to further processes for producing relatively smaller portions of shredded tire material referred to as “crumbs”. This further processing is referred to as “crumbing”, wherein either whole scrap tires or tire chips are fed to a processing unit and reduced to mall particle sizes for use in various products. In general, industry standard crumbing equipment requires an input of one-half to three-quarter inch size chips to protect crumbing equipment from excessive wear by the steel and fabric components in used or worn tires.

Rubber crumb is a valuable constituent for making new tires, pavement for roads, playground surfaces, athletic track surfaces, landscape materials, construction materials, shoes, etc., in addition to being used in the petrochemical and petroleum-refining industries.

A cracker mill is an apparatus used for producing rubber crumbs. A cracker mill shears the one-quarter to three-quarter inch size rubber chips into an output of fine-size rubber particles by compressing rubber material to its shattering or shear point. Most crumbing operations include several cracker mills in succession to achieve a 30-mesh output. The use of several cracker mills, in particular large-size cracker mills, substantially increases the cost of producing the desired size rubber crumbs or particles.

### BRIEF DESCRIPTION OF THE DRAWINGS

FIG. 1 is a schematic illustration of an example cracker mill.

FIG. 2 is a schematic illustration of a top view of the example cracker mill.

FIG. 3 is a schematic illustration of a feed augur for the example cracker mill.

FIG. 4 is a schematic illustration of an output augur and a triple deck screener for the example cracker mill.

FIG. 5 is a schematic illustration of the output augur and a recycling augur for the example cracker mill.

FIG. 6 is a schematic illustration of a motor coupled to a front roll of the example cracker mill.

FIG. 7 is a schematic illustration of coolant tubes connected to a coupling for a rear roll of the example cracker mill.

FIG. 8 is a schematic illustration of coolant tubes connected to a coupling for the front roll of the example cracker mill.

FIG. 8A is a schematic illustration of a roll gap adjustment mechanism of the example cracker mill.

FIG. 9 is a schematic illustration of a front roll lateral adjustment mechanism of the example cracker mill.

FIG. 10 is a schematic illustration of a coolant system for the example cracker mill.

FIG. 11 is a schematic illustration of a dust ventilation system for the example cracker mill.

FIG. 12 is an example flowchart representative of an example method to make rubber crumb particles.

### DETAILED DESCRIPTION

In general, the example cracker mill described herein may be utilized for milling various kinds and sizes of materials. Additionally, while the example disclosed herein is described in connection with the milling of crumb rubber in the vehicle tire reprocessing industry, the example described herein may be more generally applicable to different milling operations for different purposes.

The use of known large-size cracker mill technology involves numerous problems and costs. Large-size cracker mills used to make rubber crumb require significant capital investment for installation and operation. For example, a large-size cracker mill may have a footprint as large as 10 feet by 16 feet, be mounted on a specially poured thick concrete foundation (e.g., 18 inches in depth), and be located in a separate clean room that is dust and moisture free. The large-size cracker mill is delivered on flat bed semi-trucks and installed over several days by a millwright who levels the large-size cracker mill to one-thousandth inch per foot to obtain a perpendicular alignment of the sleeve bearings relative to the rolls. Without proper alignment, the bearings will operate at a higher temperature than desired and have a shortened service life.

A known large-size cracker mill has the motors aligned perpendicular to the rolls which are each rotated by a separate motor via a gear box. By eliminating the typical connecting gears used on large and small-sized cracker mills (e.g., a motor drives a connecting gear attached to a roll and the connecting gear drives a different sized connecting gear attached to the other roll), the rolls may be driven independently by the respective motors which are controlled electronically by controllers. The independent drive of each roll eliminates reactionary torque loads on the sleeve bearings journaling the rolls, enables the friction ratio (the speed differential between the circumferences or surfaces of the rolls) to be controlled and varied during the operation of the large-size cracker mill to create high friction ratios, and enables the conversion of the load on the slower rotating roller into power re-generation to reduce the overall power consumption of the large-size mill. Of course, the cumbersome, greasy task of, and potential injury from, removing the connecting gears is eliminated.

However, a large-size cracker mill may weigh more than 25 tons, require a 600 amp electrical service (e.g., may use 150 amp with 120-125 amp regeneration), and a programmable logic controller (PLC) grease system. Further, once installed the large-size cracker mill is immobile. The large-size cracker mill may include two 6,000 pound rolls each being approximately thirty-six inches in length and twenty-four inches in diameter. Typically, the roll material is chill cast iron, a material that is subject to slight bending or deformation after the rolls reach a higher operating temperature. Thus, due to not being sufficiently rigid, the distance of the gap between the rolls may vary. Also, the rolls are mounted on bronze sleeve bearings which have relatively large tolerances that make it hard to set and maintain a small gap between the rolls. The PLC grease system may require 400 pounds of grease about every two months, and the bronze sleeve bearings have to be replaced after a few years at a cost of thousands of dollars. The large amounts of grease utilized by a large-size mill results in grease contamination of the crumb material, thereby limiting the types of materials that may be milled. The rolls may require reworking about every six months wherein several millwrights working over several days dissemble and ship the rolls on flatbed trucks to a facility that sharpens the rolls. After being reworked about three times, the rolls must be replaced by new or reworked rolls. Typically, a large-size cracker mill may produce an output of three to six thousand pounds per hour of 30 mesh particles of rubber crumb.

The costs of installing and operating a large-size cracker mill are significant. A large-size cracker mill may cost several hundred thousand dollars, require additional concrete, electrical and plumbing work, and the rolls, bearings and periodic rework of the rolls may each cost thousands of dollars. At approximately 250° C. in low-friction ratio cracker mills having connecting gears, the chemical and structural integrity of rubber chips is affected such that devulcanization and agglomeration may occur. Additionally, large-size cracker mills cannot be easily and quickly changed from producing one mesh size crumb to another mesh size crumb.

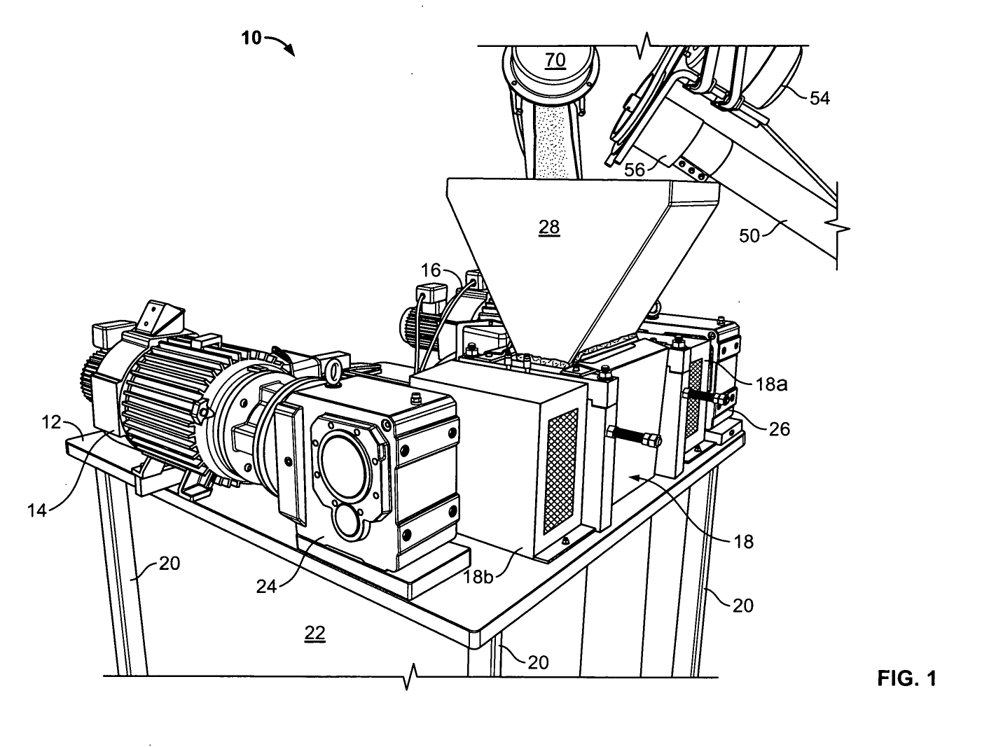

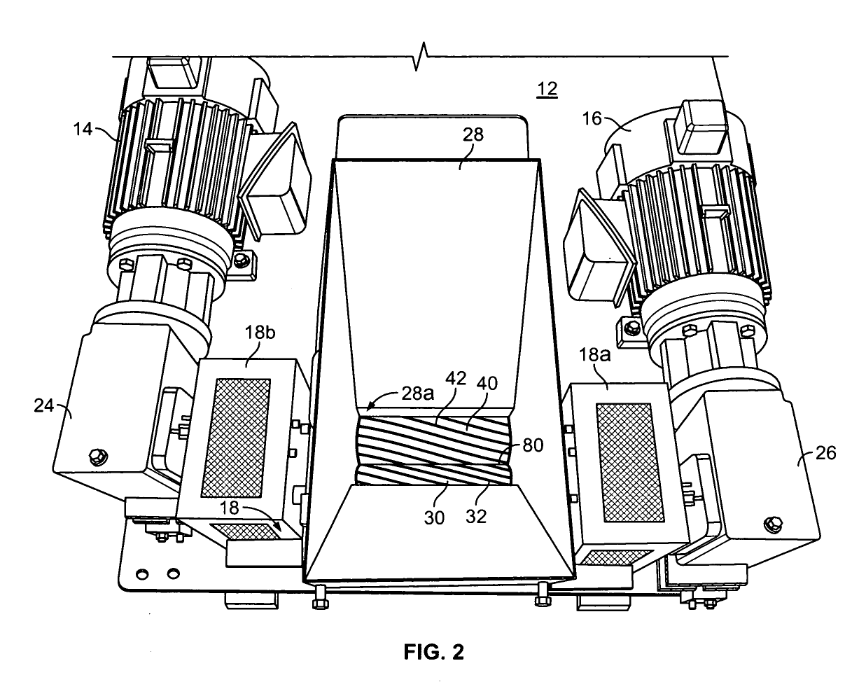

FIG. 1 is a schematic illustration of an example small-size cracker mill 10 constructed in accordance with the teachings of the invention. The example cracker mill 10 includes a base table 12 supporting a pair of motors 14 and 16. Each of the motors 14, 16 is positioned orthogonally relative to a front roll 30 and a rear roll 40, respectively, (see FIG. 2) in a mill housing 18. The motors 14 and 16 are attached to gear boxes 24 and 26, respectively. The front roll 30 is coupled to the gear box 26, and the rear roll 40 is coupled to the gear box 24. The orthogonal alignment of the motors 14 and 16 relative to the rolls 30 and 40 reduces significantly the width of the base table 12 to enable the base table 12 to be generally square-shaped and better balanced. The motor 14 via the gear box 24 drives independently the rear roll 40, and the motor 16 via the gear box 26 drives independently the front roll 30. The motors 14 and 16 are controlled by electronic controllers (not shown).

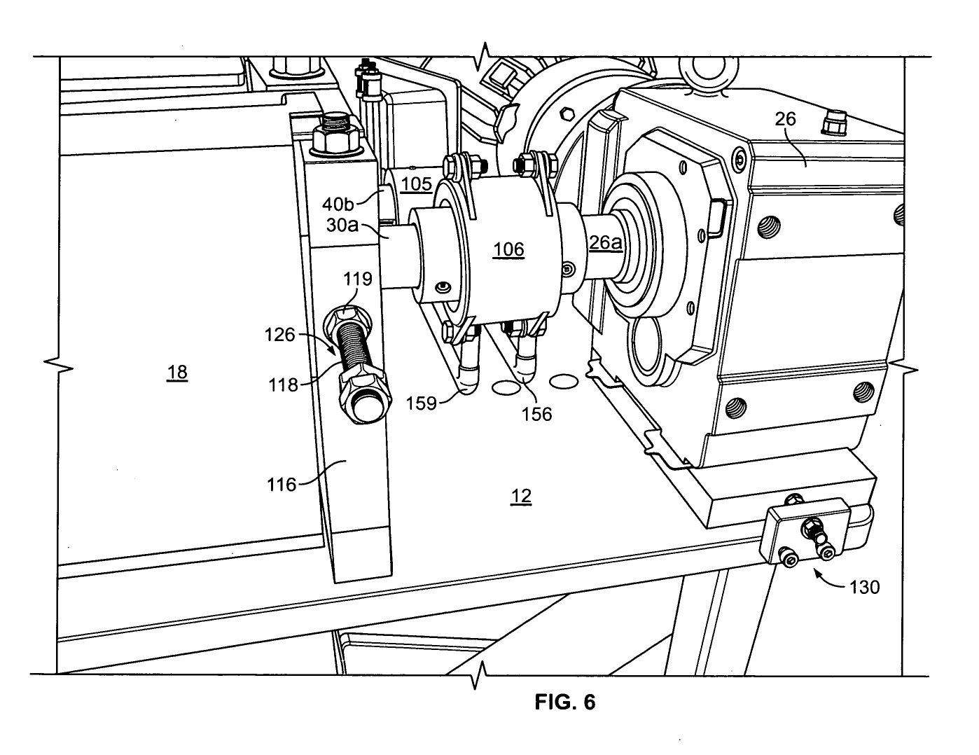

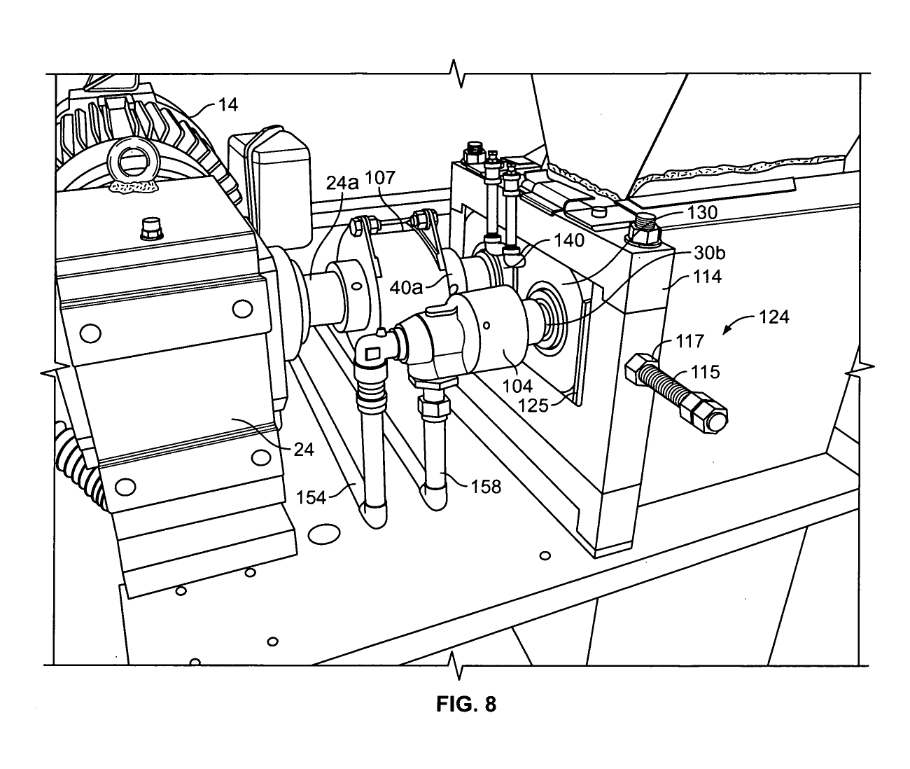

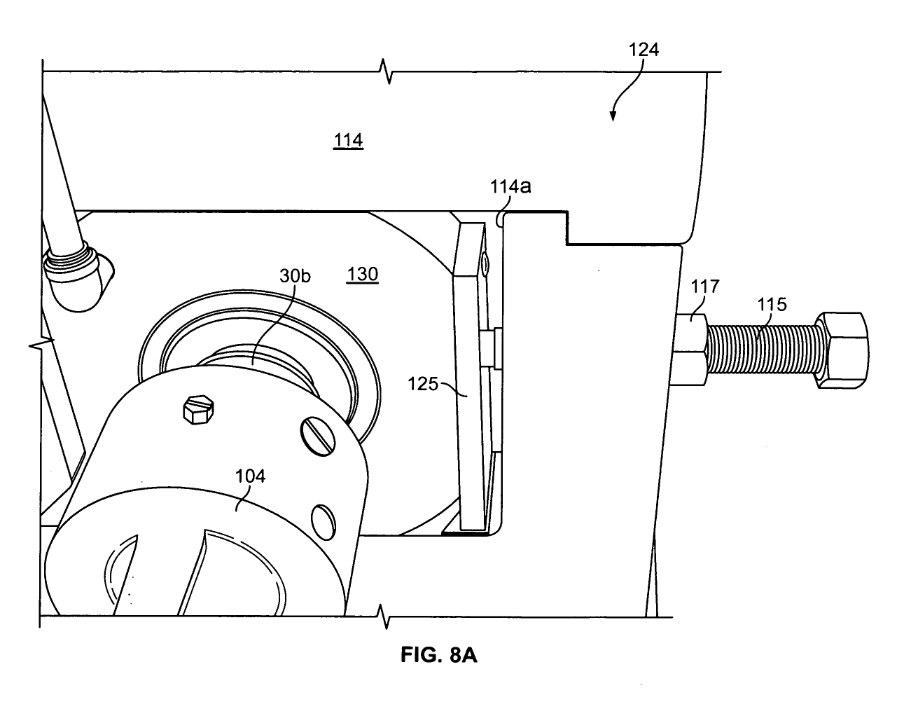

The mill housing 18 includes ventilated coupling housings 18a and 18b (see FIGS. 1 and 2) covering a first drive coupling 106 (see FIG. 6) connecting to the gear box 26 to the front roll 30 and a second drive coupling 107 (see FIG. 8) connecting the gear box 24 to the rear roll 40, respectively. As shown in FIG. 1, the base table 12 has four supports 20 that support the motors 14 and 16, the gear boxes 24 and 26, and the mill housing 18 a predetermined distance above a floor 22.

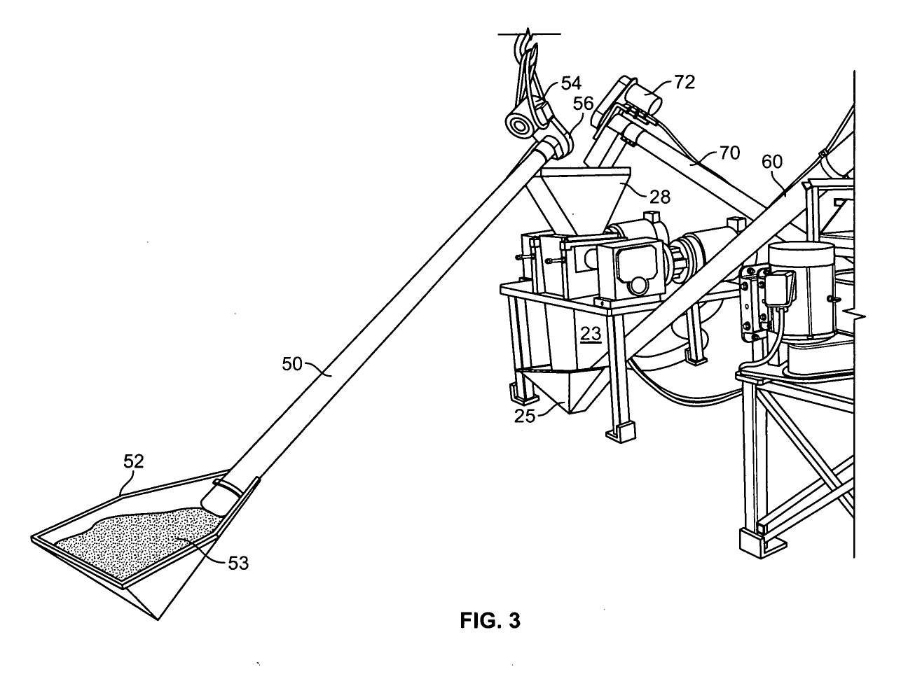

As illustrated in FIGS. 1-3, the example cracker mill 10 includes a feed hopper 28 located above the mill housing 18 to feed material to the rolls 30 and 40. A feed augur 50 and a recycling augur 70 supply material to the hopper 28. Referring to FIG. 3, the example cracker mill 10 has an output chute 23 positioned above an output hopper 25 located below the base table 12 and on the floor 22.

Referring again to FIG. 2, the front roll 30 and the rear roll 40 have spiral-shaped corrugations 32 and 42, respectively. The corrugations 32 and 42 are eleven degree opposed-spirals, so that there is a twenty-two degree difference between the corrugations 32 and 42 at a scissors point where the rolls 30 and 40 contact the crumb material. The rolls 30 and 40 are made of 8620 alloy hardened steel which has a high degree of stiffness to provide rigidity to resist bending in a radial direction. Generally, 8620 alloy hardened steel is not known to be used to make the rolls of large-size cracker mills. Each roll 30 and 40 is approximately twelve inches in length and approximately six inches in diameter. The rolls 30 and 40 are positioned closely adjacent one another (see FIG. 2) to create between them a very small gap 80 (e.g., a gap of two to three thousands of an inch). The feed hopper 28 has a bottom chute 28a that extends to about one eighth of an inch from the rolls 30 and 40 to ensure that rubber crumb material in the feed hopper 28 is directed by the rolls 30 and 40 to the gap 80.

FIG. 3 is a schematic illustration of the feed augur 50 for the example cracker mill 10. The feed augur 50 includes an input hopper 52 to receive rubber material or chips 53 to be milled by the example cracker mill 10, a variable frequency electric motor 54 to operate the augur 50, and a grain gate or outlet chute 56 to direct rubber material into the feed hopper 28.

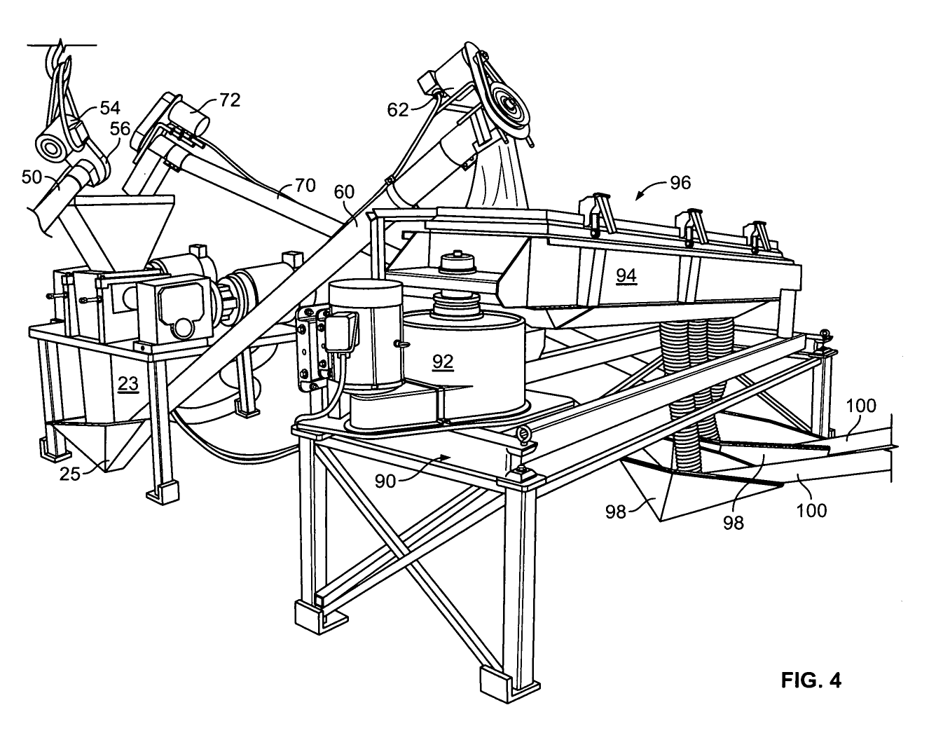

FIG. 4 is a schematic illustration of an output augur 60 and a triple deck screener 90 for the example cracker mill 10. The output augur 60 is operated by a variable frequency electric motor 62 to transmit rubber crumb particles in the output hopper 25 to the triple deck screener 90. The triple deck screener 90 includes: (a) an eccentric drive motor 92 to oscillate a screener deck 94 and (b) three screens 96 to sort the rubber crumb particles into one or more sizes of particles such as, for example, 10 mesh size particles, 20 mesh size particles, and/or 30 mesh size particles. The sorted particles that have at least a desired or final size such as, for example, 30 mesh size particles, are fed into one or more outlet hoppers 98 located below the screener 90 and then transported by one or more augurs 100 to storage containers, vessels or areas (not shown).

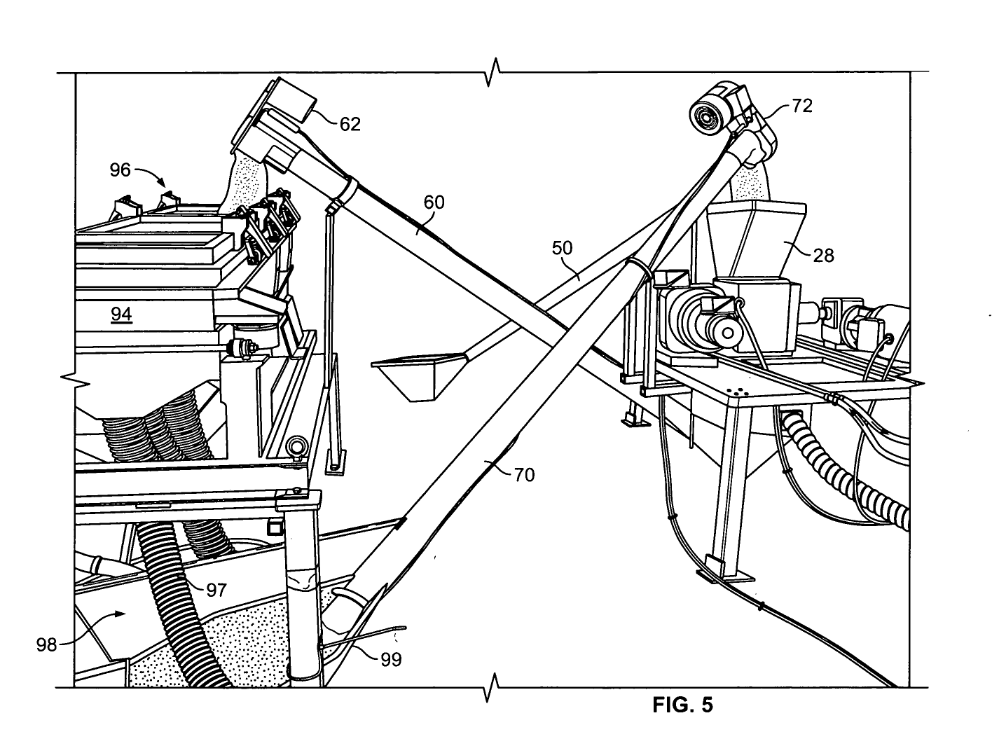

FIG. 5 is an illustration of the input augur 50, the output augur 60, the recycling augur 70 (which is driven by a variable frequency electric motor 72), and the screener 90. The sorted crumb particles in the screener 90 that are larger than desired, such as, for example, 10 and 20 mesh size particles, are directed through a hose 97 to a recycling hopper 99 located below the screener 90. The recycling augur 70 transmits the large-size sorted particles from the recycling hopper 99 back to the input hopper 28 of the example cracker mill 10 to be further reduced in size.

In FIG. 6, the ventilated housing 18a has been removed to show the gear box 26 coupled to a roll shaft 30a of the front roll 30. The gear box 26 includes a drive shaft 26a attached to the coupling 106 connected to the roll shaft 30a. The roll shaft 30a is journaled in a self-aligning spherical bearing in an opening (not shown) of a bearing pedestal 116 that includes an adjustment screw 118 and a lock nut 119 of a first roll gap adjustment mechanism 126. Partially shown in FIG. 6 is a coolant coupling 105 attached to a roll shaft 40b of the rear roll 40. The roll shaft 40b is journaled in a self-aligning spherical bearing located within an opening (not shown) of the bearing pedestal 116. A coolant feed tube 156 and a coolant return tube 159 are attached to the coolant coupling 105. The coolant tubes 156, 159 supply coolant to the rear roll 40.

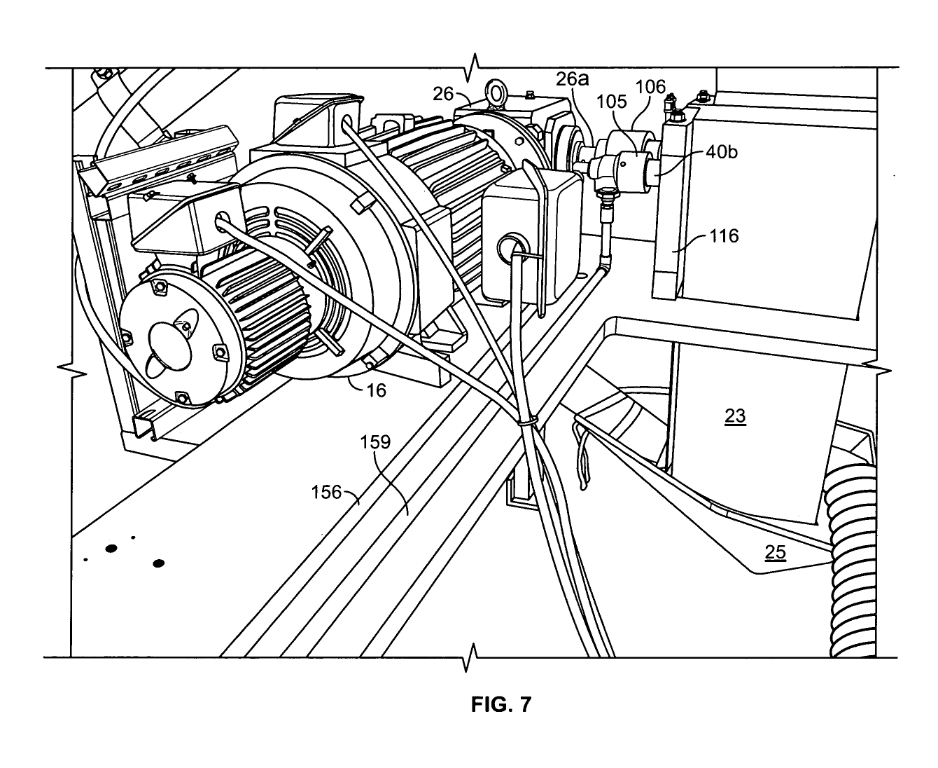

FIG. 7 illustrates schematically an opposite side of the bearing pedestal 116, the coolant coupling 105 attached to the roll shaft 40b of the rear roll 40, the coolant feed tube 156, and the coolant return tube 159.

Referring now to FIGS. 8 and 8a, a second roll gap adjustment mechanism 124 is located at a bearing pedestal 114, and a coolant coupling 104 is attached to a roll shaft 30b of the front roll 30 and also to coolant tubes 154 and 158. The coolant tubes 154, 158 supply coolant to the front roll 30. The second roll gap adjustment mechanism 124 includes an adjustment screw 115 received within a threaded opening (not shown) in the bearing pedestal 114, a lock nut 117, and a pusher plate 125 located in a pedestal opening 114a. The pusher plate 125 abuts a self-aligning spherical bearing 130 which journals the roll shaft 30b. Referring again to FIG. 6, the first roll gap adjustment mechanism 126 also includes a similar pusher plate in a pedestal opening that abuts a self-aligning spherical bearing (not shown) journaling the roll shaft 30a. The adjustment screw 118 engages the pusher plate abutting the self-aligning spherical bearing. By adjusting the positions of the adjustment screws 115 and 118 of the roll gap adjustment mechanisms 124 and 126, respectively, the position of the front roll 30 relative to the rear roll 40 may be adjusted to change the size of the gap 80 between the rolls 30 and 40.

Referring again to FIG. 8, the gear box 24 is coupled by the second drive coupling 107 to the rear roll 40 of the example cracker mill 10. The gear box 24 includes a drive shaft 24a attached to the second drive coupling 107 connected to a roll shaft 40a of the rear roll 40. The roll shaft 40a is journaled within a self-aligning spherical bearing 140 located adjacent the self-aligning spherical bearing 130 within the opening 114a of the bearing pedestal 114. It is known to use self-aligning bearings on small mills operated by connecting gears, but the use of self-aligning bearings on small mills operated without connecting gears appears to be new.

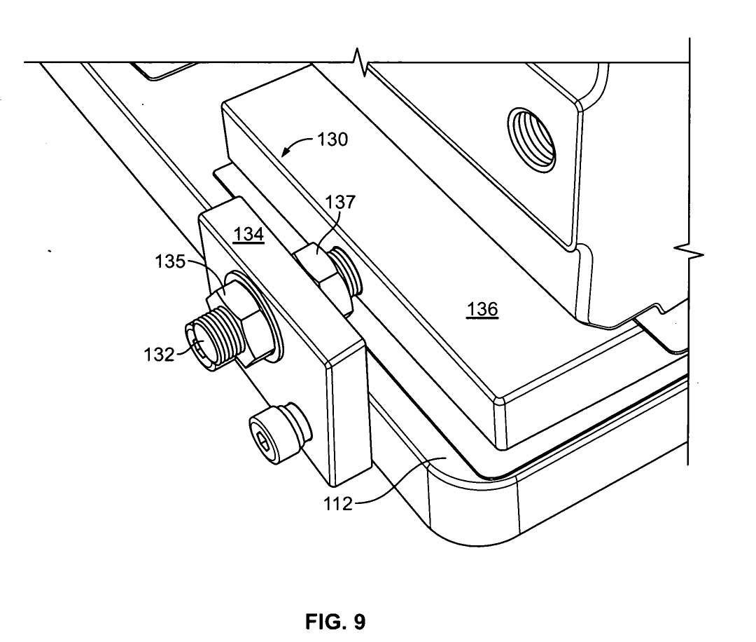

The adjustment of the position of the front roll 30 relative to the rear roll 40 also requires adjustment of the position of the first drive coupling 106, shown in FIG. 6, attached to the roll shaft 30a and the drive shaft 26a of the gear box 26. A front roll lateral adjustment mechanism 130 is illustrated schematically in FIG. 6 and in more detail in FIG. 9. The front roll lateral adjustment mechanism 130 includes an adjustment screw 132 received in a threaded opening (not shown) in a plate 134 attached to a base plate 112 located on the base table 12 of the example cracker mill 10. The adjustment screw 132 has lock nuts 135 and 137 located on opposite sides of the plate 134. The screw 132 abuts a movable plate 136 supporting the gear box 26. When the roll gap adjustment mechanisms 124 and 126 are adjusted to change the size of the gap 80 between the front roll 30 and the rear roll 40, the position of the adjustment screw 132 in the plate 134 is adjusted correspondingly to change the position of the movable plate 136. The movement of the movable plate 136 achieves a corresponding change in the position of the gear box 26, the drive shaft 26a, and the coupling 106 which engages the shaft 30a of the front roll 30, and, thus, maintains the alignment of the coupling 106 with the front roll 30.

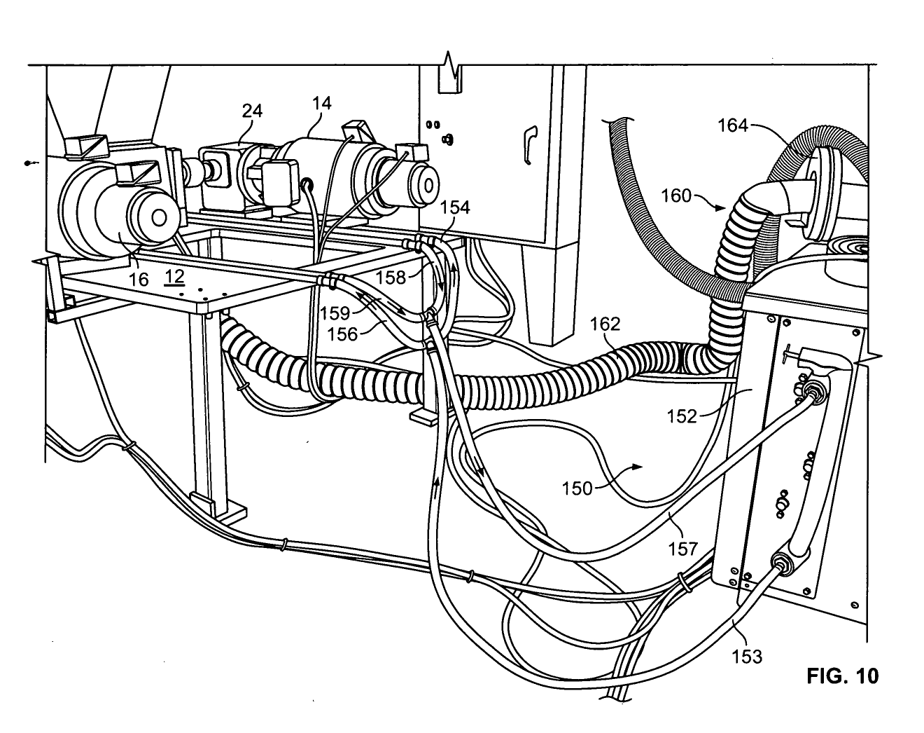

FIG. 10 is a schematic illustration of a coolant system 150 for the front roll 30 and the rear roll 40 of the example cracker mill 10. The coolant system 150 includes a coolant chilling unit 152 connected to a coolant feed tube 153 that branches into coolant feed tubes 154 and 156, and a coolant return tube 157 is connected to coolant return tubes 158 and 159. A coolant such as, for example, water, may be used as the cooling medium of the coolant system 150.

The coolant system 150 transmits coolant through the coolant feed tube 153 to the coolant feed tubes 154 and 156 and the coolant couplings 104 and 105, respectively. The coolant coupling 104 transmits the coolant to the roll shaft 30b (see FIG. 8), through a center passage (not shown) in the front roll 130, to the opposite end of the roll 30 adjacent the roll shaft 30a (see FIG. 6) where the coolant exits radially outwardly from the center passage and returns to the roll shaft 30b through radially outer passages (not shown) in the front roll 30. The coolant then passes to the coolant coupling 104 and the return tubes 158 and 157. In a similar manner, in FIG. 7 the coolant coupling 105 transmits coolant received from the coolant feed tube 156 to the roll shaft 40b of the rear roll 40. The coolant passes through a center passage (not shown) in the rear roll 40, to the opposite end of the roll 40 adjacent the roll shaft 40a (see FIG. 8) where the coolant exits radially outwardly from the center passage. The coolant then returns to the roll shaft 40b through radially outer passages (not shown) in the rear roll 40. It then passes to the coolant coupling 105 and the return tubes 159 and 157. Typically, the coolant system 150 maintains the front roll 30 and the rear roll 40 in the temperature range of approximately 92° F. to approximately 88° F., ±approximately 2° F.

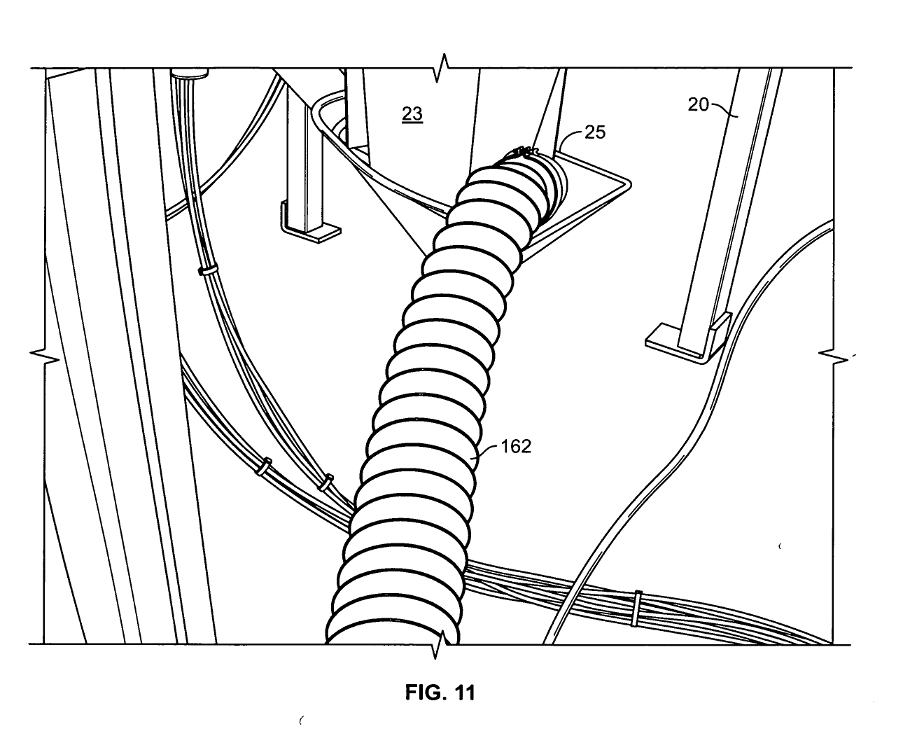

FIGS. 10 and 11 illustrate a dust ventilation system 160 for the example cracker mill 10. As shown in detail in FIG. 11, the output hopper 25 includes a ventilation hose 162 which is connected to a blower mechanism 164 (see FIG. 10) that transmits dust to a collection container (not shown).

Referring to FIG. 3, during operation of the example cracker mill 10, the rubber material or chips 53 are transported by the feed augur 50 to the feed hopper 28 and the bottom chute 28a. The rubber material 53 is fed by the rotating front roll 30 and rear roll 40 into the gap 80 (e.g., through a distance of about one quarter inch) whereupon the rubber material 53 is compressed and sheared quickly to smaller mesh size crumb particles (e.g., such as 30 mesh, 40 mesh or smaller depending on the desired use of the particles). The rear roll 40 is rotated by the motor 16 at a speed slower than the speed at which the front roll 30 is rotated by the motor 14, to produce a friction ratio between the rolls 30 and 40. The friction ratio is the ratio of the surface or circumferential speeds of the rolls 30 and 40, and may be varied over a wide range via the controllers (not shown) during the operation of the example cracker mill 10. Either of the rolls 30 and 40 may be the slower rotating roll. The smaller mesh size crumb particles fall through the output chute 23 into the output hopper 25, and are transported by the output augur 60 to the triple deck screener 90 (see FIG. 4). The triple deck screener 90 sorts the smaller mesh size crumb particles into different size crumb particles. The desired mesh size crumb particles (for example, 30 mesh size crumb particles) are separated from the larger mesh size crumb particles. The particles of the desired size fall to the outlet hopper 98 from which they are transported by one or more augurs 100 to storage containers or areas. The larger mesh size crumb particles fall into the recycling hopper 99 and are transported by the recycling augur 70 back into the feed hopper 28 for further size reduction via another pass through the example small-size cracker mill 10.

During operation, the example cracker mill 10 maintains the small gap 80 between the rolls 30 and 40 through which the material 53 and any recycled crumb particles are milled. The self-aligning spherical bearings (e.g., self-aligning spherical bearings 130 and 140 in FIG. 8) journaling the ends of the rolls 30 and 40 have small tolerances which prevent the rolls 30 and 40 from moving relative to each other, and, thus, contribute significantly to maintaining the small gap 80. Additionally, the rolls 30 and 40 are each made of 8620 hardened steel alloy and have a relatively short axial length of about twelve inches, so that the rolls 30 and 40 do not bend or warp, and, thus, maintain the small gap 80 of the example cracker mill 10.

The output particles of the example cracker mill 10 may depend on the kind (e.g., the consistency, internal materials, and structure) of the material or chips 53 to be processed. For example, truck tire chips of approximately three-sixteenths inch size can be milled to 10 mesh size particles at a rate of about 750 lb/hr. A second pass through the example cracker mill 10 can produce particles milled to a 20-30 mesh size at a rate of approximately 250 lb/hr. However, car tire chips of approximately three-sixteenths inch size can be milled in one pass through the example cracker mill 10 to 10 mesh size particles at a rate of approximately 250 lb/hr.

The example cracker mill 10 displaces the rubber material or chips 53 approximately one quarter of an inch in the small gap 80. Compared to a large-size cracker mill, the example cracker mill 10 compresses and shears the material or chips 53 faster or quicker. As a result, the example cracker mill 10 can require proportionally less electrical power for operation than could be expected for a large-size cracker mill. This further reduces the overall expected installation, operation and maintenance costs of the example cracker mill 10.

The example cracker mill 10 of FIGS. 1-11 provides numerous advantages over large-size cracker mills. The example cracker mill 10 may occupy a floor footprint of about 4 feet by 6 feet, have a weight of about 6000 pounds and a motor control located in a small cabinet (i.e., a clean room is not required). The example cracker mill 10 may be transported in a small pick-up truck, and be installed immediately on a production floor without any specialized or modified flooring. If desired, the example cracker mill 10 may be moved by a forklift to a new operation location. Specialized installation skills, such as, for example, those of a millwright, are not required to install the example cracker mill 10. The installation cost of the example cracker mill 10 may be about one quarter to one fifth of the cost of installing a large-size mill.

The self-aligning spherical bearings (e.g., the self-aligning bearings 130 and 140 in FIG. 8) of the example cracker mill 10 can be lubricated by a hand grease gun about once per month, and grease consumption is a few cubic centimeters per month. The self-aligning spherical bearings 130 and 140 have a service life of 7-10 years and can cost less than $25 each. The rolls 30 and 40 may be reworked several times during a service life of approximately two years, and be replaced at a cost of less than $2500 each. Two persons using hand tools can replace the rolls 30 and 40 in about an hour. Likewise, the position of the front roll 30 can be adjusted quickly so the example cracker mill 10 produces a different size particle.

The example cracker mill 10 may be connected to an 80 amp power service and use 30 amps with 10 amp regeneration. Because the example cracker mill 10 does not have grease contamination of the material or chips being processed, elastomer materials, metals, plastics, paper or wood may be milled by the example cracker mill 10. The lower overall power consumption of electric power as a result of power re-generation, and the use of miniscule amounts of grease, by the example cracker mill 10 provide an excellent example of the implementation and use of what has become known as green technology.

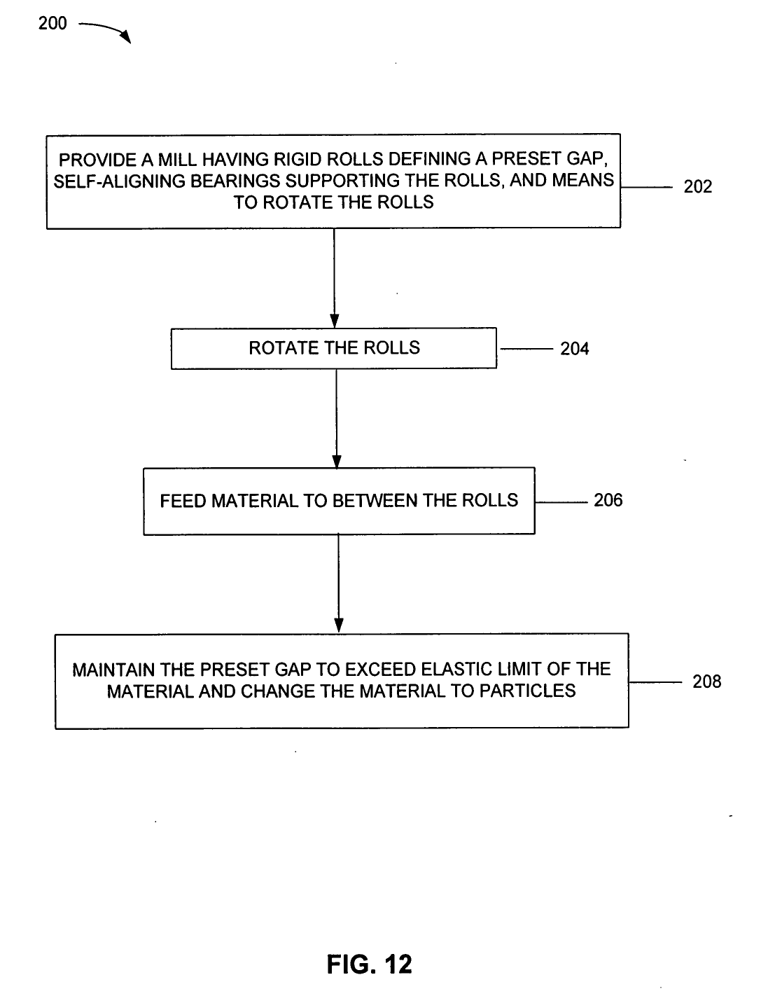

A flowchart representative of an example method 200 to make particles by using the example cracker mill 10 of FIGS. 1-11 is shown in FIG. 12. Initially, at block 202 of the example method 200, a mill (e.g., the example cracker mill 10 in FIGS. 1-11) having rigid rolls (e.g., the front roll 30 and the rear roll 40 of the example cracker mill 10 in FIG. 2) defining a preset gap (e.g., the gap 80 in FIG. 2), self-aligning bearings (e.g., the self-aligning spherical bearings 130 and 140 in FIGS. 8 and 8A) supporting the rolls (e.g., the front roll 30 and the rear roll 40 of the example cracker mill 10 in FIG. 2), and means to rotate the rolls (e.g., the motors 14 and 16, the gear boxes 24 and 26, and the couplings 106 and 107 of the example cracker mill 10 of FIGS. 1-11) are provided. The example mill may include the rolls made of 8620 alloy steel (e.g., the front roll 30 and the rear roll 40 in the example cracker mill 10 in FIGS. 1-11). Each roll may be approximately six inches in diameter and twelve inches long (e.g., the front roll 30 and the rear roll 40 in the example cracker mill 10 of FIG. 1-11). The rotating means may be aligned orthogonally relative to the rolls (e.g., the motors 14 and 16, and the gear boxes 24 and 26, aligned orthogonally relative to the rolls 30 and 40 in the example cracker mill 10 of FIGS. 1-11). The rolls of the mill are rotated (e.g., the motors 14 and 16, the gear boxes 24 and 26, and the couplings 106 and 107 rotate the rolls 30 and 40 in the example cracker mill 10 of FIGS. 1-11), block 204, and material (e.g., the rubber material or chips 53 in FIG. 3) is fed to between the rolls (e.g., the front roll 30 and the rear roll 40 in the example cracker mill 10 of FIGS. 1-11), block 206. The material (e.g., the material or chips 53 in FIG. 3) may be an elastomer, metal, plastic, paper, or wood. The preset gap (e.g., the gap 80 in FIG. 2) is maintained to exceed the elastic limit of the material (e.g., the material or chips 53 in FIG. 3) and to crush or shear the material to particles, block 208.

Although the example method 200 is described with reference to the flowchart illustrated in FIG. 12, persons of ordinary skill in the art will readily appreciate that many other methods of implementing the example cracker mill 10 may be used alternatively. For example, the order of execution of the blocks may be changed, and/or some of the blocks described may be changed, eliminated, or combined.

Although certain example methods and apparatus have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to make particles, comprising:
rotating a pair of rigid rolls disposed closely adjacent one another via self-aligning bearings that support the rigid rolls with a preset gap therebetween;
feeding material between the rigid rolls; and
maintaining the preset gap to exceed the elastic limit of the material.

2. A method as claimed in claim 1, wherein the rigid rolls are made of 8620 alloy steel.

3. A method as claimed in claim 1, wherein the self-aligning bearings are spherical.

4. A method as claimed in claim 1, wherein the material is at least one of tire chips, an elastomer, a metal, a plastic, paper, or wood.

5. A method as claimed in claim 1, wherein the material is converted to particles without lubricant on the particles.

6. A method as claimed in claim 1, wherein the rigid rolls each have approximately a six inch diameter and approximately a twelve inch length.

7. A method as claimed in claim 1, wherein the material is converted into particles having a size of approximately 30 mesh.

8. A method as claimed in claim 1, wherein feeding the material further comprises displacing the material between the rigid rolls approximately one quarter inch to compress and shear the material into particles.

9. A method as claimed in claim 1, wherein rotating the rolls comprises actuating first and second motors, each of the first and second motors aligned orthogonally relative to and driving independently a respective one of the rigid rolls.

10. A method as claimed in claim 1, further comprising providing complementarily-shaped corrugations on the rigid rolls to compress and shear the material into particles.

11. A method as claimed in claim 1, wherein the rolls and self-aligning bearings are part of a mill, the mill further includes a base table, and further comprising moving the mill as a unit to an operating location.

12. A method as claimed in claim 1, wherein each of the rigid rolls has approximately eleven-degree spiral corrugations such that the rolls provide approximately a twenty-two degree difference between the corrugations of the rigid rolls.

13. A method to make crumb particles, comprising:
rotating a pair of rigid rolls via self-aligning bearings that support the rigid rolls with a preset gap therebetween, each rigid roll having complementarily-shaped corrugations disposed closely adjacent the corrugations of the other rigid roll;
feeding material between the rigid rolls a distance of approximately one quarter inch; and
maintaining the preset gap to exceed the elastic limit of the material and convert the material to particles.

14. A method to make rubber crumb particles, comprising:
rotating a pair of rigid rolls via self-aligning spherical bearings that support the rigid rolls with a preset gap therebetween, each roll having complementarily-shaped corrugations disposed closely adjacent the corrugations of the other rigid roll, and each rigid roll aligned orthogonally relative to and driven independently by a respective motor;
feeding material between the rigid rolls a distance of approximately one quarter inch; and
maintaining the preset gap to exceed the elastic limit of the material.

15. A mill to make particles, comprising:
a pair of rigid rolls disposed closely adjacent one another to define a preset gap therebetween;
self-aligning spherical bearings to support the rigid rolls; and
means for rotating the rigid rolls, wherein the preset gap is maintained to convert the material to particles.

16. A mill as claimed in claim 15, wherein the rigid rolls are made of 8620 alloy steel.

17. A mill as claimed in claim 15, wherein the material is at least one of tire chips, an elastomer, a metal, a plastic, paper, or wood.

18. A mill as claimed in claim 15, wherein the rigid rolls each have approximately a twelve inch length and a six inch diameter.

19. A mill as claimed in claim 15, wherein the material is converted to particles without lubricant on the particles.

20. A mill as claimed in claim 15, wherein the material is displaced between the rigid rolls approximately one quarter inch to compress and shear the material into particles.

21. A mill as claimed in claim 15, wherein the means for rotating comprises first and second motors to rotate respective ones of the rigid rolls, each of the first and second motors aligned orthogonally relative to and driving independently their respective rigid roll.

22. A mill as claimed in claim 15, wherein the rigid rolls have corrugations that together provide approximately a twenty-two degree difference between the corrugations of the rigid rolls.

23. A mill as claimed in claim 15, wherein the mill includes a base table located a distance from a floor, and the mill is movable as a unit.

24. A mill to make rubber crumb particles, comprising:
a pair of rigid rolls each with spiral corrugations disposed closely adjacent the spiral corrugations of the other rigid roll to define a preset gap therebetween;
self-aligning spherical bearings to support the rigid rolls; and
a motor to rotate each rigid roll, wherein the preset gap is maintained so that the elastic limit of material fed between the rigid rolls a distance of approximately one quarter inch is exceeded to convert the material to rubber crumb particles.

25. A mill as claimed in claim 24, wherein the spiral corrugations provide approximately a twenty-two degree difference between the corrugations of the rigid rolls.
